(19) United States
(12) Patent Application Publication
(10) Pub. No.: US 2025/0376211 A1
(43) Pub. Date: Dec. 11, 2025

(54) STEERING FEEDBACK ACTUATOR

(71) Applicant: HYUNDAI MOBIS CO., LTD., Seoul (KR)

(72) Inventor: Chang Wook SON, Yongin-si (KR)

(73) Assignee: HYUNDAI MOBIS CO., LTD., Seoul (KR)

(21) Appl. No.: 19/010,891

(22) Filed: Jan. 6, 2025

(30) Foreign Application Priority Data
Jun. 11, 2024 (KR) 10-2024-0075629

(51) Int. Cl. B62D 5/00; B62D 5/04

(52) U.S. Cl. CPC B62D 5/006; B62D 5/0412

(57) ABSTRACT

A steering feedback actuator including a housing part, a steering column configured to be rotatably accommodated within the housing part and arranged in a first direction, a first gear part coupled to the steering column and configured to rotate with the steering column, and an electric motor part including a motor housing coupled to the housing part configured to cover an opening of the housing part and a motor shaft rotatably coupled to the motor housing, the motor shaft including a second gear part configured to engage with the first gear part.

### CROSS-REFERENCE TO RELATED APPLICATION

This application claims priority from and the benefit under 35 USC § 119 of Korean Patent Application No. No. 10-2024-0075629, filed on Jun. 11, 2024, in the Korean Intellectual Property Office, the entire disclosure of which is incorporated by reference for all purposes.

### BACKGROUND

### 1. Field

Embodiments of the present disclosure relate to a steering feedback actuator, and more particularly, to a steering feedback actuator applied to a steer-by-wire (SBW) system.

### 2. Description of the Related Art

In general, power steering systems for vehicles are hydraulic steering systems that generate hydraulic pressure by using an oil pump driven by engine power to generate steering assistance. As such hydraulic steering systems have the disadvantages of requiring a large number of components and having relatively complex structures, research and development is being conducted on a steer-by-wire (SBW) system that transmits the driver's steering intentions to the driving wheels via electrical signals, without a mechanical connection between the steering wheel and the driving wheels.

A SBW system includes a steering feedback actuator (SFA) and a road wheel actuator (RWA). When the steering wheel rotates, the vehicle's electronic control unit (ECU) receives the steering angle as an electrical signal, and based on this electrical signal, drives the RWA to steer the driving wheels. The SBW system may easily change the steering ratio in response to the driving situation of the vehicle, thereby improving driving comfort and vehicle stability.

Conventional SFAs include a reducer and a motor, wherein the reducer includes a worm reducer, a belt type reducer, and a planetary gear reducer. These reducers have complex mechanisms due to their structural characteristics, resulting in high manufacturing costs and high probability of quality control problems. In addition, such reducers are prone to noise due to gear backlash thereof. Therefore, there is a need to improve these drawbacks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a steering feedback actuator including a housing part, a steering column configured to be rotatably accommodated within the housing part and arranged in a first direction, a first gear part coupled to the steering column and configured to rotate with the steering column, and an electric motor part including a motor housing coupled to the housing part configured to cover an opening of the housing part and a motor shaft rotatably coupled to the motor housing, the motor shaft including a second gear part configured to engage with the first gear part.

The motor shaft may be arranged in the first direction alongside the steering column.

The electric motor part further may include a flange provided in the motor housing, the flange configured to abut the housing part and having a first through-hole defined therein and a fastening member, the first through-hole may be configured to receive the fastening member, the fastening member being configured to be fastened to a tapped hole defined within the housing part and to extend through the first through-hole.

The first through-hole may be provided as an elongated opening in a second direction intersecting the first direction.

A first diameter of the first through-hole may be larger than a second diameter of the tapped hole.

The flange further includes a plurality of the first through-holes defined therein and the plurality of first through-holes may be spaced apart from each other in a circumferential direction of the flange.

The electric motor part further may include a guide protrusion configured to protrude from the motor housing in the first direction, the first direction being in a circumferential direction of the motor housing, the guide protrusion being further configured to be inserted into the housing part.

A gap may be defined between the guide protrusion and the opening to allow the motor housing to move in the second direction.

The housing part further may include a second through-hole defined therein and arranged in the second direction, and the steering feedback actuator may further include a pin part configured to be screw-coupled to the second through-hole, the pin part configured to support the guide protrusion.

An interaxial distance between the steering column and the motor shaft may be configured to vary depending on a rotation direction of the pin part.

The first gear part may include one of a plastic material and a metal material and the second gear part may include a plastic material.

### BRIEF DESCRIPTION OF THE DRAWINGS

FIG. 1 is a one-sided cross-sectional view schematically illustrating a steering feedback actuator according to a first embodiment of the present disclosure;

FIG. 2 is an enlarged cross-sectional view of section “A” of FIG. 1;

FIG. 3 is an enlarged perspective view of section “A” of FIG. 1;

FIG. 4 is a cross-sectional view schematically illustrating the coupling relationship between a housing part and an electric motor part in the steering feedback actuator according to the first embodiment of the present disclosure;

FIGS. 5 and 6 are cross-sectional views illustrating the steering feedback actuator according to the first embodiment of the present disclosure, viewed in a first direction;

FIG. 7 is a one-sided cross-sectional view schematically illustrating a steering feedback actuator according to a second embodiment of the present disclosure;

FIG. 8 is an enlarged cross-sectional view of section “A” of FIG. 7;

FIG. 9 is an enlarged perspective view of section “A” of FIG. 7;

FIG. 10 is a cross-sectional view schematically illustrating the coupling relationship between a housing part and an electric motor part in the steering feedback actuator according to the second embodiment of the present disclosure; and

FIGS. 11 and 12 are cross-sectional views illustrating the steering feedback actuator according to the second embodiment of the present disclosure, viewed in a first direction.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

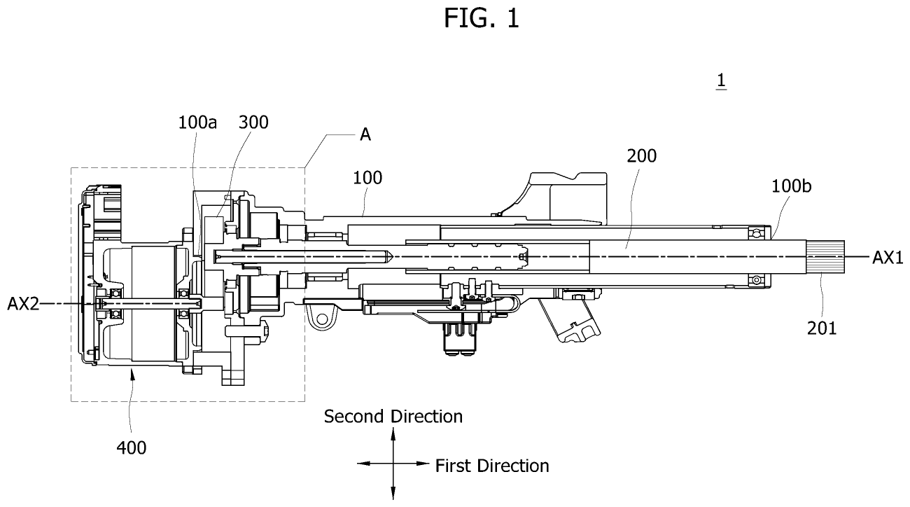

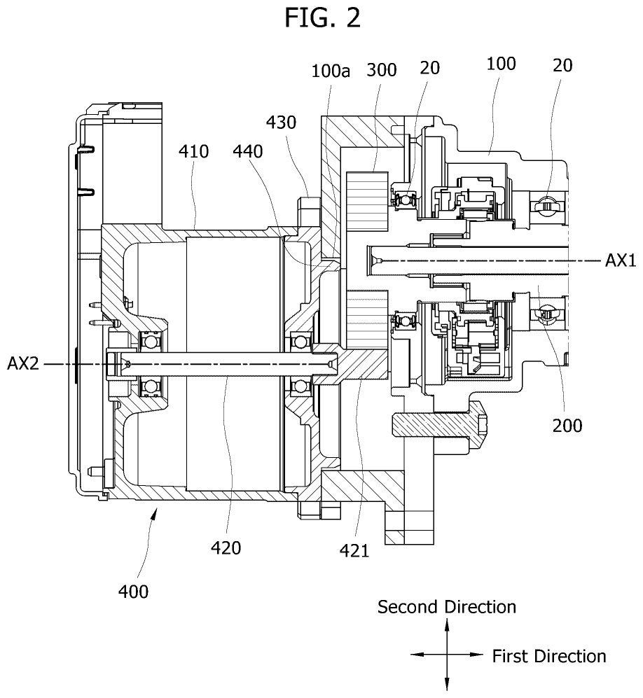

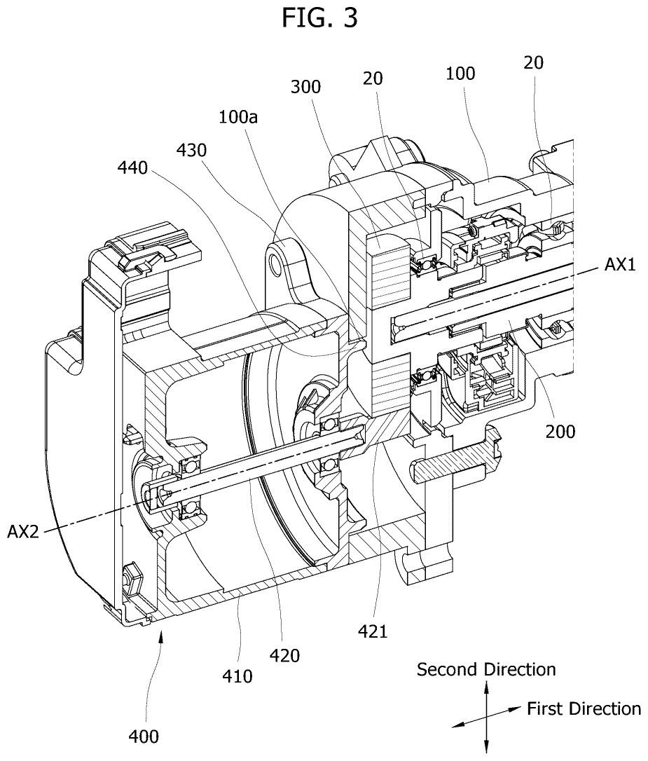

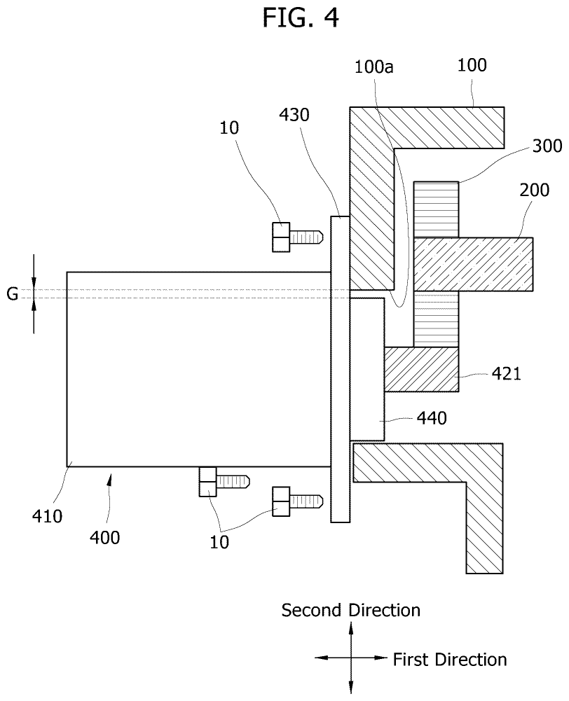

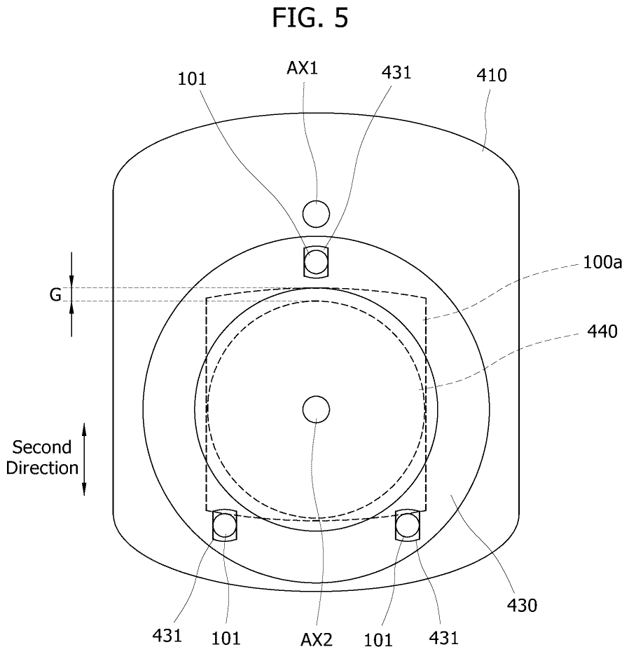

FIG. 1 is a one-sided cross-sectional view schematically illustrating a steering feedback actuator according to a first embodiment of the present disclosure, FIG. 2 is an enlarged cross-sectional view of section “A” of FIG. 1, FIG. 3 is an enlarged perspective view of section “A” of FIG. 1, FIG. 4 is a cross-sectional view schematically illustrating the coupling relationship between a housing part and an electric motor part in the steering feedback actuator according to the first embodiment of the present disclosure, and FIG. 5 is a cross-sectional view illustrating the steering feedback actuator according to the first embodiment of the present disclosure, viewed in a first direction.

Referring to FIGS. 1 to 5, the steering feedback actuator 1 according to the first embodiment of the present disclosure includes a housing part 100, a steering column 200, a first gear part 300, and an electric motor part 400, which will be described in detail as follows.

The housing part 100 forms a schematic outline of the steering feedback actuator 1 according to the first embodiment of the present disclosure, and may generally support the steering column 200, the first gear part 300 and the electric motor part 400, which will be described below.

The specific shape of the housing part 100 is not limited to the shape illustrated in FIG. 1, but various design changes are possible within the technical idea of a shape capable of generally supporting the configuration of the steering feedback actuator 1 according to the first embodiment of the present disclosure.

The housing part 100 may be formed to have the shape of a hollow barrel. The steering column 200 may be accommodated within the housing part 100.

Both longitudinal sides of the housing part 100 may be open. One longitudinal side of the housing part 100 adjacently to the electric motor part 400 to be described later may be provided with an opening 100a. The opening 100a may be formed at one side of the housing part 100 in the longitudinal direction of the housing part 100.

Through-holes 100b may be formed on the other longitudinal side of the housing part 100. The through-holes 100b may be formed at the other side of the housing part 100 in the longitudinal direction of the housing part 100. One side of the steering column 200 may be exposed from the housing part 100 through the through-holes 100b.

The steering column 200 may be axially mounted on an inner side of the housing part 100. The steering column 200 may be arranged in a first direction. Additionally, the steering column 200 may be arranged alongside the longitudinal direction of the housing part 100. That is, the first direction may be the same direction as the longitudinal direction of the housing part 100. Further, the first direction may be the same direction as the direction of the central axis AX1 of the steering column 200.

A spline 201 may be provided on one side of the steering column 200 that is exposed through the through-hole 100b formed on the other longitudinal side of the housing part 100. The spline 201 may be formed on an outer circumferential surface of the steering column 200. A steering wheel (not shown) may be coupled to one side of the steering column 200 on which the spline 201 is formed. Thus, the steering column 200 may be axially rotated in association with the rotation of the steering wheel.

An inner side of the housing part 100 may house bearings 20 that rotatably support the steering column 200. The bearings 20 may be installed between the housing part 100 and the steering column 200. The bearings 20 may be spaced apart from each other in the longitudinal direction of the housing part 100.

The first gear part 300 may be coupled to the steering column 200. The first gear part 300 may be coupled to the other side of the steering column 200 facing the opening 100a formed on one longitudinal side of the housing part 100. The steering column 200 may be axially coupled to the first gear part 300. The other side of the steering column 200 may be axially coupled to the central portion of the first gear part 300.

The first gear part 300 may rotate with the steering column 200. The first gear part 300 may rotate in the same direction as the rotation direction of the steering column 200. The first gear part 300 may include a helical gear.

The first gear part 300 may be formed of a plastic material. In another embodiment, the first gear part 300 may be formed of a metal material, such as steel.

The electric motor part 400 may be coupled to the housing part 100. The electric motor part 400 may be powered from an external power source to generate rotational force. The electric motor part 400 may employ various motors, such as an AC, DC, or BLDC motor, that convert power input from an external power source into rotational force, and may generate reaction force in a direction that prevents the steering column 200 from rotating according to the rotation of the steering wheel.

The reaction force generated by the electric motor part 400 allows the driver rotating the steering wheel to feel a change in steering direction by hand.

The electric motor part 400 may include a motor housing 410, a motor shaft 420, a flange 430, and a guide protrusion 440.

The motor housing 410 may be coupled to the housing part 100. The motor housing 410 may be coupled to one longitudinal side of the housing part 100 where the opening 100a is formed. The motor housing 410 may be arranged adjacently to one longitudinal side of the housing part 100 to cover the opening 100a of the housing part 100. The motor housing 410 may be coupled to the housing part 100 in a direction alongside the longitudinal direction of the housing part 100.

The motor shaft 420 may be rotatably coupled to the motor housing 410. The motor shaft 420 may be arranged in a first direction. The motor shaft 420 may protrude from the motor housing 410 in the first direction. The motor shaft 420 may be inserted into the housing part 100 through the opening 100a of the housing part 100.

The motor shaft 420 may be spaced apart from the steering column 200 and may be arranged alongside the steering column 200. The motor shaft 420 may have a second gear part 421 that meshes with the first gear part 300. The second gear part 421 may be provided on one side of the motor shaft 420 that is inserted into the housing part 100.

The second gear part 421 may be formed of a metal material, such as steel. The second gear part 421 may include a helical gear. The second gear part 421 may be integrally formed with the motor shaft 420.

The flange 430 may be provided on the motor housing 410. The flange 430 may protrude from an outer circumferential surface of the motor housing 410 and may be formed in a circumferential direction of the motor housing 410. The flange 430 may abut an outer surface of the housing part 100 facing the direction in which the motor housing 410 is located.

The flange 430 may be provided with first through-holes 431. The first through-holes 431 may be formed to penetrate the flange 430 in the thickness direction. The first through-holes 431 may be spaced apart from each other in the circumferential direction of the flange 430. At least three first through-holes 431 may be formed in the flange 430.

Fastening members 10 may extend through the first through-holes 431 and fastened to the housing part 100. Each of the fastening members 10 may be illustrated as a bolt or the like that is screw-coupled to the housing part 100. The motor housing 410 may be secured to the housing part 100 by the fastening members 10 being screwed into a tapped hole 101 formed in the housing part 100 through the first through-holes 431.

The first through-holes 431 may be formed in the shape of an elongated opening in a second direction intersecting the first direction. The second direction may refer to a direction of interaxial distance between the central axis AX1 of the steering column 200 and the central axis AX2 of the motor shaft 420. Additionally, the second direction may refer to a direction in which the central axis AX1 of the steering column 200 and the central axis AX2 of the motor shaft 420, which are arranged in parallel, move closer to or away from each other.

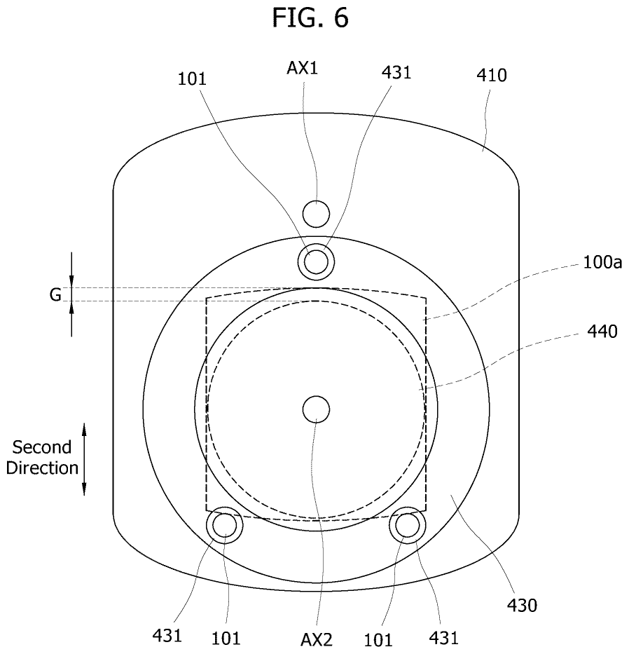

FIG. 6 is a cross-sectional view illustrating the steering feedback actuator according to the first embodiment of the present disclosure, viewed in a first direction.

Referring to FIG. 6, the diameter of the first through-holes 431 may be formed to be larger than the diameter of the tapped hole 101 formed in the housing part 100 through the thickness direction.

The guide protrusion 440 may protrude from the motor housing 410 in a first direction and may be formed in a circumferential direction of the motor housing 410. The guide protrusion 440 may be inserted into the housing part 100 through the opening 100a of the housing part 100.

The diameter of the guide protrusion 440 may be formed to be smaller than the diameter of the opening 100a formed in the housing part 100. A gap G may be formed between the guide protrusion 440 and the opening 100a to allow the motor housing 410 to move in the second direction. The gap G may range from 0.1 cm to 0.3 cm.

The opening 100a may be formed in the shape of an elongated opening in the second direction. Both sides of the opening 100a may be abutted to both sides of the guide protrusion 440. The opening 100a may guide linear movement of the guide protrusion 440.

Prior to attaching the motor housing 410 to the housing part 100, the fastening members 10 are pre-fitted through the first through-holes 431 into the tapped holes 101 formed in the housing part 100, and then the motor housing 410 is moved in the second direction to adjust the interaxial distance between the central axis AX1 of the steering column 200 and the central axis AX2 of the motor shaft 420. This makes it possible to adjust the backlash between the first gear part 300 and the second gear part 421.

As the motor housing 410 is moved in the second direction, the interaxial distance between the steering column 200 and the motor shaft 420 may be varied.

After adjusting the interaxial distance between the central axis AX1 of the steering column 200 and the central axis AX2 of the motor shaft 420, the fastening members 10 are tightened to securely fix the motor housing 410 to the housing part 100 so that the motor housing 410 is not moved in the second direction.

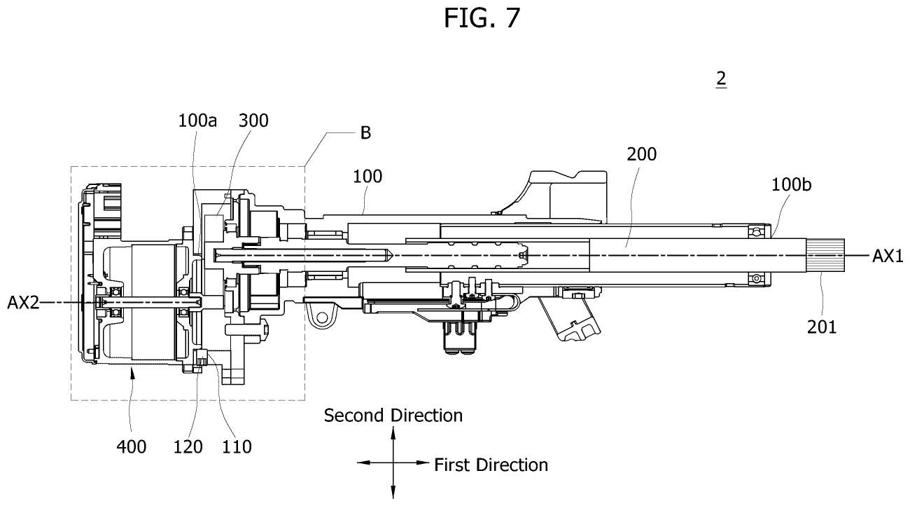

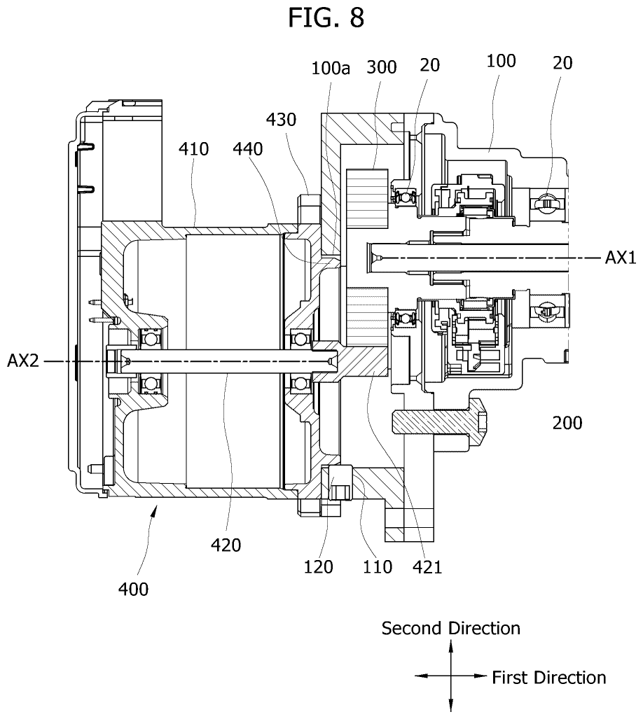

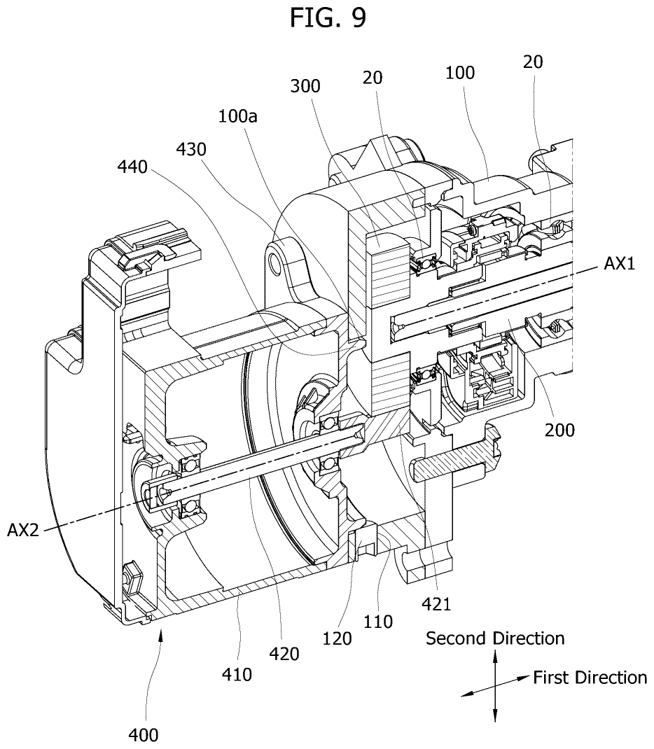

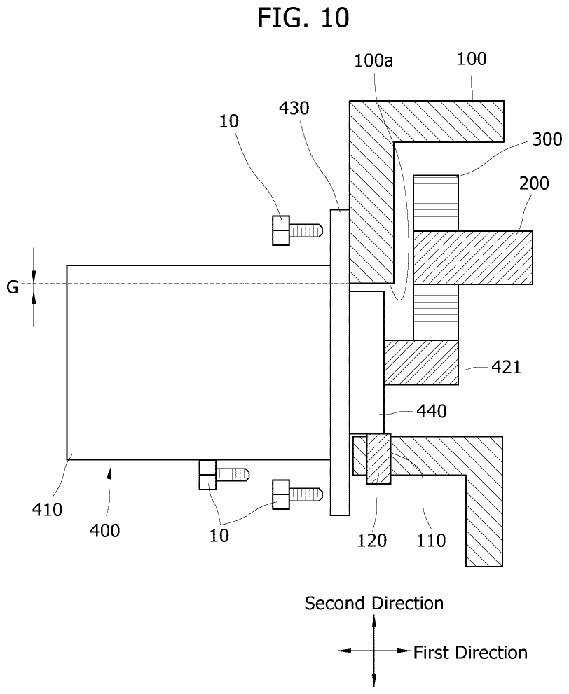

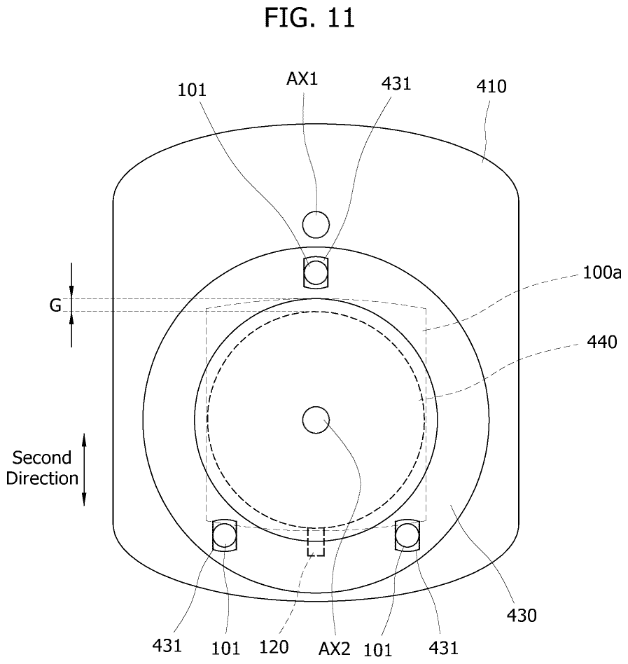

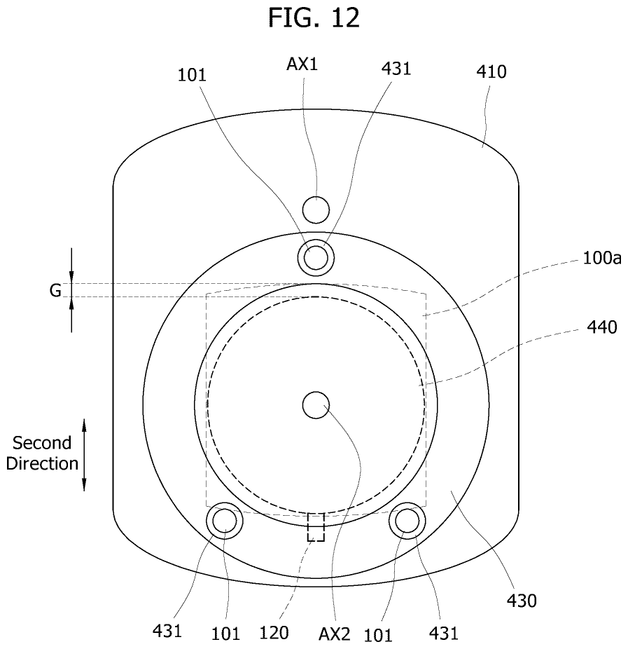

FIG. 7 is a one-sided cross-sectional view schematically illustrating a steering feedback actuator according to a second embodiment of the present disclosure, FIG. 8 is an enlarged cross-sectional view of section “A” of FIG. 7, FIG. 9 is an enlarged perspective view of section “A” of FIG. 7, FIG. 10 is a cross-sectional view schematically illustrating the coupling relationship between a housing part and an electric motor part in the steering feedback actuator according to the second embodiment of the present disclosure, and FIGS. 11 and 12 are cross-sectional views illustrating the steering feedback actuator according to the second embodiment of the present disclosure, viewed in a first direction.

Referring to FIGS. 7 to 12, the steering feedback actuator 2 according to the second embodiment of the present disclosure may include a housing part 100, a steering column 200, a first gear part 300, an electric motor part 400, and a pin part 120.

In describing the steering feedback actuator 2 according to the second embodiment of the present disclosure, only a different embodiment of the housing part 100 of the steering feedback actuator 1 according to the first embodiment and the pin part 120, which was not described in the steering feedback actuator 1 according to the first embodiment of the present disclosure, will be described.

For the rest of the configuration of the steering feedback actuator 2 according to the second embodiment, the description of the steering feedback actuator 1 according to the first embodiment may be applied as it is.

The housing part 100 may be provided with a second through-hole 110. The second through-hole 110 may be formed through an outer circumferential surface of the housing part 100 in a second direction. The second through-hole 110 may be formed on the opening 100a side of the housing part 100. The second through-hole 110 may be internally threaded along the inner circumferential surface.

The pin part 120 may be coupled to the second through-hole 110. The pin part 120 may be screw-coupled to the inner circumferential surface of the second through-hole 110. The pin part 120 may be arranged in a second direction. The pin part 120 may extend through the second through-hole 110 to support the guide protrusion 440. The pin part 120 may be illustrated as a bolt or the like.

The interaxial distance between the steering column 200 and the motor shaft 420 may be varied depending on the rotation direction of the pin part 120, which is screw-coupled to and extends through the second through-hole 110 and supports the guide protrusion 440.

After the motor housing 410 is attached to the housing part 100 by screwing the fastening members 10, which extend through the first through-hole 431 formed in the flange 430, into the tapped hole 101 formed in the housing part 100, the pin part 120 presses the guide protrusion 440 by rotating the pin part 120, which is screw-coupled to the second through-hole 110 formed in the housing part 100 and supports the guide protrusion 440, in one direction.

The guide protrusion 440, which is pressed by the pin part 120, is moved in the second direction in which the steering column 200 is located, and the interaxial distance between the central axis AX1 of the steering column 200 and the central axis AX2 of the motor shaft 420 is adjusted accordingly. This makes it possible to adjust the backlash between the first gear part 300 and the second gear part 421.

As the motor housing 410 is moved in the second direction, the interaxial distance between the steering column 200 and the motor shaft 420 may be varied.

Conversely, by reverse rotation of the pin part 120 pressing the guide protrusion 440, the guide protrusion 440 may be moved opposite to the direction in which the steering column 200 is located. Accordingly, the interaxial distance between the central axis AX1 of the steering column 200 and the central axis AX2 of the motor shaft 420 may be adjusted. This makes it possible to adjust the backlash between the first gear part 300 and the second gear part 421.

As the motor housing 410 is moved in the second direction, the interaxial distance between the steering column 200 and the motor shaft 420 may be varied.

In the steering feedback actuators 1 and 2 according to the embodiments of the present disclosure, the interaxial distance between the steering column 200 having the first gear part 300 and arranged in the first direction and the motor shaft 420 having the second gear part 421 engaged with the first gear part 300 and arranged in the first direction alongside the steering column 200 may be adjusted, so that the backlash between the first gear part 300 and the second gear part 421 may be adjusted.

In the steering feedback actuators 1 and 2 according to the embodiments of the present disclosure, the first gear part 300 is formed of a metal material and the second gear part 421 engaged with the first gear part 300 is formed of a plastic material, so that noise generated by the backlash between the first gear part 300 and the second gear part 421 may be reduced.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A steering feedback actuator, comprising:
a housing part;
a steering column configured to be rotatably accommodated within the housing part and arranged in a first direction;
a first gear part coupled to the steering column and configured to rotate with the steering column; and
an electric motor part comprising:
a motor housing coupled to the housing part configured to cover an opening of the housing part; and
a motor shaft rotatably coupled to the motor housing, the motor shaft comprising a second gear part configured to engage with the first gear part.

2. The steering feedback actuator of claim 1, wherein the motor shaft is arranged in the first direction alongside the steering column.

3. The steering feedback actuator of claim 1, wherein the electric motor part further comprises:
a flange provided in the motor housing, the flange configured to abut the housing part and having a first through-hole defined therein; and
a fastening member,
wherein the first through-hole is configured to receive the fastening member, the fastening member being configured to be fastened to a tapped hole defined within the housing part and to extend through the first through-hole.

4. The steering feedback actuator of claim 3, wherein the first through-hole is provided as an elongated opening in a second direction intersecting the first direction.

5. The steering feedback actuator of claim 4, wherein a first diameter of the first through-hole is larger than a second diameter of the tapped hole.

6. The steering feedback actuator of claim 4, wherein the flange further includes a plurality of the first through-holes defined therein, and
wherein the plurality of first through-holes are spaced apart from each other in a circumferential direction of the flange.

7. The steering feedback actuator of claim 4, wherein the electric motor part further comprises:
a guide protrusion configured to protrude from the motor housing in the first direction, the first direction being in a circumferential direction of the motor housing, the guide protrusion being further configured to be inserted into the housing part.

8. The steering feedback actuator of claim 7, wherein a gap is defined between the guide protrusion and the opening to allow the motor housing to move in the second direction.

9. The steering feedback actuator of claim 7, wherein the housing part further includes a second through-hole defined therein and arranged in the second direction, and
wherein the steering feedback actuator further comprises:
a pin part configured to be screw-coupled to the second through-hole, the pin part configured to support the guide protrusion.

10. The steering feedback actuator of claim 9, wherein an interaxial distance between the steering column and the motor shaft is configured to vary depending on a rotation direction of the pin part.

11. The steering feedback actuator of claim 1, wherein the first gear part comprises one of:
a plastic material and a metal material, and
wherein the second gear part comprises:
a plastic material.
